(19) United States
(12) Patent Application Publication
(10) Pub. No.: US 2015/0149113 A1
(43) Pub. Date: May 28, 2015

(54) APPARATUS FOR TRANSMITTING POSITION OF MULTI-AXIS TRANSPORT SYSTEM AND METHOD THEREOF

(71) Applicant: KOREA PLANT SERVICE & ENGINEERING CO., LTD., Seongnam (KR)

(72) Inventors: Gyung Sub KIM, Suwon (KR); Min Su PARK, Seongnam (KR); Dong Il KIM, Yongin (KR); Bae Jun KANG, Yongin (KR); Hong Seok RYU, Yongin (KR); Jun Hong KIM, Yongin (KR); Youn Kyu KIM, Seoul (KR)

(21) Appl. No.: 14/550,558

(22) Filed: Nov. 21, 2014

(30) Foreign Application Priority Data
Nov. 26, 2013 (KR) 10-2013-0144297

(51) Int. Cl. G01D 5/26; G01B 21/00

(52) U.S. Cl. CPC G01D 5/26; G01B 21/00
USPC 702/152

(57) ABSTRACT

The present disclosure relates to an apparatus for transmitting a position of a multi-axis transport system and a method thereof, and provides an apparatus for transmitting a position of a multi-axis transport system capable of providing an accurately detected position of a nondestructive system to a user by converting a sensor signal for measuring a position of the multi-axis transport system into position information (x, y, and z coordinates) which may be matched to the detected position of the nondestructive system and then transmitting the converted position information to the nondestructive system via high speed communication (e.g., Local Area Network (LAN) or Peripheral component Interconnect (PCI)), and a method thereof.

### CROSS-REFERENCE TO RELATED APPLICATION

This application is based on and claims the benefit of priority to Korean Patent Application No. 10-2013-0144297, filed on Nov. 26, 2013 in the Korean Intellectual Property Office, the disclosure of which is incorporated herein in its entirety by reference.

### TECHNICAL FIELD

The present disclosure relates to an apparatus for transmitting a position of a multi-axis transport system and a method thereof, and more particularly, to a technology for converting a sensor signal for measuring a position of a multi-axis transport system into position information (x, y, and z coordinates) which may be matched to a detected position of a nondestructive system and then transmitting the converted position information to the nondestructive system via high speed communication (e.g., Local Area Network (LAN) or Peripheral component Interconnect (PCI)).

### BACKGROUND

In the case in which a nondestructive examination related to a nuclear reactor (radiation zone) is performed using a robot, an end-effector capable of operating a probe for a nondestructive examination is separately mounted at an end portion of a joint of the robot to perform the work. This is typically referred to as a multi-axis transport system.

The multi-axis transport system is mainly deployed in a field to which it is difficult for human to access, that is, a field in which it is difficult for a manual nondestructive system to be used and performs the nondestructive examination. Conventionally, in order to provide a detected position, a scanner capable of obtaining x and y axes information has been used, or in the case in which the scanner is not available, a manipulator, or the like has been used.

In the case in which the manipulator is used as described above, since a position mapping is performed by a single synchronous signal (pulse form), it is difficult to accurately detect the position, and particularly, a three-dimensional position (x, y, and z coordinates) may not be detected.

### SUMMARY

The present disclosure has been made to solve the above-mentioned problems occurring in the prior art while advantages achieved by the prior art are maintained intact.

An aspect of the present disclosure provides an apparatus for transmitting a position of a multi-axis transport system capable of providing an accurately detected position of a nondestructive system to a user by converting a sensor signal for measuring a position of the multi-axis transport system into position information (x, y, and z coordinates) which may be matched to the detected position of the nondestructive system and then transmitting the converted position information to the nondestructive system via high speed communication (e.g., Local Area Network (LAN) or Peripheral component Interconnect (PCI)), and a method thereof.

The object of the present disclosure is not limited to the above-mentioned object, but other objects and advantages of the present disclosure can be appreciated by the following description and will be clearly described by the embodiments of the present disclosure. In addition, it will be easily known that the objects and advantages of the present disclosure can be implemented by means and a combination thereof shown in the appended claims.

According to an exemplary embodiment of the present disclosure, an apparatus for transmitting a position of a multi-axis transport system includes: a sensor signal input device configured to be linked to the multi-axis transport system and receive a variety of sensor signals for measuring the position; a position coordinate generator configured to generate three-dimensional position coordinates based on the variety of sensor signals for measuring the position which are received by the sensor signal input device; and a position coordinate transmitter configured to transmit the three-dimensional position coordinates which are generated by the position coordinate generator to a nondestructive system.

According to another exemplary embodiment of the present disclosure, a method for transmitting a position of a multi-axis transport system includes: receiving, by a sensor signal input device, a variety of sensor signals for measuring the position by being linked to the multi-axis transport system; generating, by a position coordinate generator, three-dimensional position coordinates based on the variety of received sensor signals for measuring the position; and transmitting, by a position coordinate transmitter, the generated three-dimensional position coordinates to a nondestructive system.

### BRIEF DESCRIPTION OF THE DRAWINGS

The above and other objects, features and advantages of the present disclosure will be more apparent from the following detailed description taken in conjunction with the accompanying drawings.

FIG. 1 is a configuration diagram of an apparatus for transmitting a position of a multi-axis transport system according to an exemplary embodiment of the present disclosure.

FIG. 2 is a flow chart of a method for transmitting a position of a multi-axis transport system according to an exemplary embodiment of the present disclosure.

### DETAILED DESCRIPTION

The above-mentioned objects, features, and advantages will become obvious from the detailed description which is described below in detail with reference to the accompanying drawings. Therefore, those skilled in the art to which the present disclosure pertains may easily practice a technical idea of the present disclosure. Further, in describing the present disclosure, in the case in which it is judged that a detailed description of a well-known technology associated with the present disclosure may unnecessarily make unclear the gist of the present disclosure, it will be omitted. Hereinafter, exemplary embodiments of the present disclosure will be described in detail with reference to the accompanying drawings.

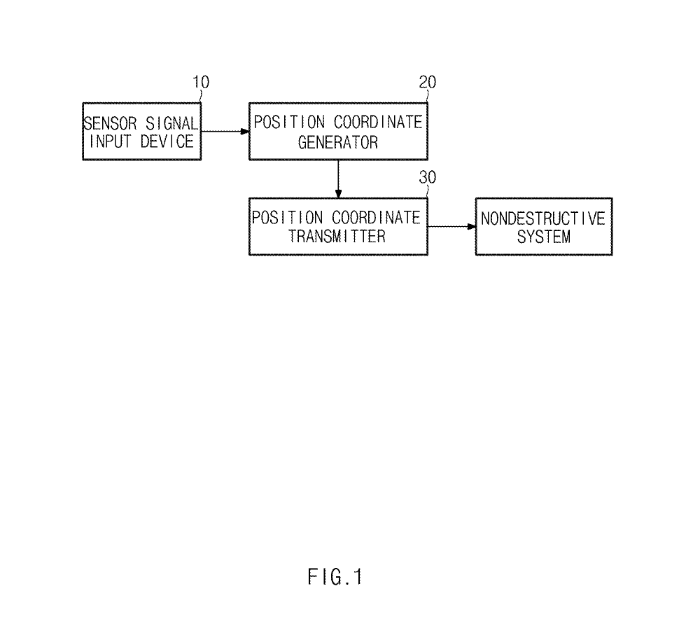

FIG. 1 is a configuration diagram of an apparatus for transmitting a position of a multi-axis transport system according to an exemplary embodiment of the present disclosure.

As shown in FIG. 1, the apparatus for transmitting the position of the multi-axis transport system according to the exemplary embodiment of the present disclosure includes a sensor signal input device 10, a position coordinate generator 20, and a position coordinate transmitter 30.

Each of the above-mentioned respective components will be described. First, the sensor signal input device 10 is linked to the multi-axis transport system to receive a variety of sensor signals. These sensor signals, which are sensor signals for measuring the position of the multi-axis transport system, include the sensor signals which are generated by an encoder, a resolver, a potentiometer, and the like.

The encoder, which is a sensor measuring a position of an object in a photoelectric way, is used for measuring a length and an angle and includes a photoelectric linear encoder and a photoelectric rotary encoder which use a slit column and a photoelectric converting element.

The resolver, which is an angular sensor having a two-phase winding at stator and rotor, respectively, is used as an operation component, particularly, an operation component of a trigonometrical function.

The potentiometer, which is a variable resistor converting liner displacement and rotation displacement into a change in electric resistance, includes a contact type and a non-contact type. The contact type has a structure in which a brush moves on a resistor, a liner type of the potentiometer has a stroke up to about 1,000 mm, and a rotation type of the potentiometer includes a single rotation type to a multi-rotation type.

Next, the position coordinate generator 20 generates three-dimensional position coordinates (x, and coordinates) based on a variety of sensor signals for measuring the position which are received through the sensor signal input device 10. Here, two-dimensional position coordinates (x and y coordinates) and the three-dimensional position coordinates (x, y, and z coordinates) are generated by using the sensor signals for measuring the position which are generated by the encoder, the sensor signals for measuring the position which are generated by the resolver, and/or the sensor signals for measuring the position which are generated by the potentiometer.

As an example, the position coordinate generator 20 generates three-dimensional position coordinates (Px, Py, Pz) using the following Equation 1.

$$[ \begin{matrix}Px \\ Py \\ Pz \\ Φ \\ Θ \\ Ψ\end{matrix} ] = [ T ] [ \begin{matrix}{q}_{1} \\ {q}_{2} \\ {q}_{3} \\ {q}_{4} \\ {q}_{5} \\ {q}_{6}\end{matrix} ] \qquad [ Equation 1 ]$$

Here, φ represents a roll of the multi-axis transport system (multi-axis type device), θ represents a pitch of the multi-axis transport system (multi-axis type device), ψ represents a yaw of the multi-axis transport system (multi-axis type device), T represents a kinematic transformation matrix, and qn, which is the sensor signal, represents a rotation amount of motor of each axis. In this case, n is a natural number, and in the case of a 6-axis device, n represents 1 to 6.

Next, the position coordinate transmitter 30 transmits the three-dimensional position coordinates which are generated by the position coordinate generator 20 to the nondestructive system.

The above-mentioned position coordinate transmitter 30 may be implemented by two schemes, wherein one scheme is a scheme transmitting a position coordinate to the nondestructive system in User Datagram Protocol (UDP) scheme or Transmission Control Protocol/Internet Protocol (TCP/IP) scheme by including an LAN communication interface, and the other scheme is a scheme which is implemented in a form of Peripheral Component Interconnect (PCI) bus and transmits the position coordinate to the nondestructive system.

In this case, the scheme transmitting the position coordinate to the nondestructive system via the LAN communication has an advantage that it is possible to be performed if the nondestructive system includes an LAN communication module regardless of a kind and specification of nondestructive system, and the scheme transmitting the position coordinate to the nondestructive system via the PCI bus has an advantage that it may be specialized for a specific nondestructive system.

The apparatus for transmitting the position of the multi-axis transport system according to the present invention described above may be implemented in a form of a high speed embedded system.

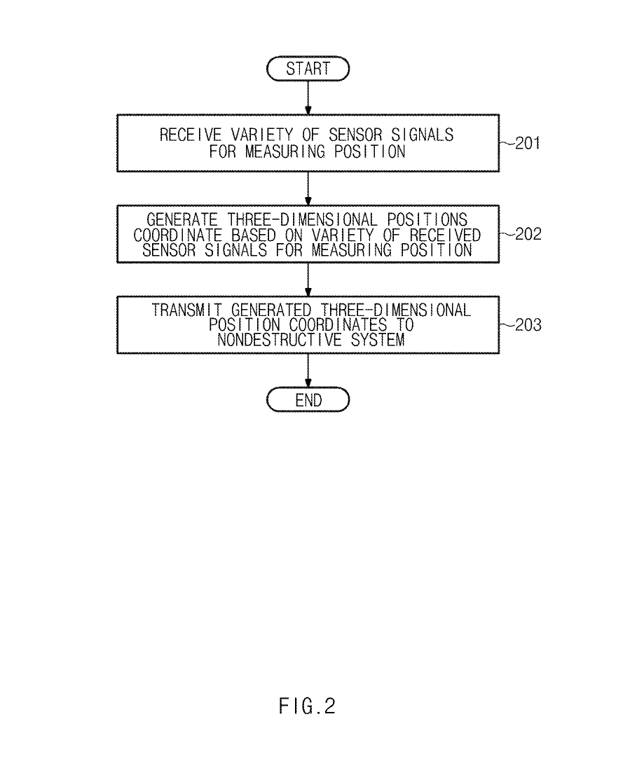

FIG. 2 is a flow chart of a method for transmitting a position of a multi-axis transport system according to an exemplary embodiment of the present disclosure.

First, a sensor signal input device 10 is linked to a multi-axis transport system and receives a variety of sensor signals for measuring a position (201).

Next, a position coordinate generator 20 generates three-dimensional coordinates based on the variety of sensor signals for measuring the position which are received through the sensor signal input device 10 (202).

Next, a position coordinate transmitter 30 transmits the three-dimensional position coordinates which are generated by the position coordinate generator 20 to a nondestructive system (203).

Meanwhile, the method according to the present invention as described above may be created by a computer program. Codes and code segments configuring the computer program may be easily deduced by computer programmers in the art. In addition, the created computer program is stored in a computer readable recording medium (information storage medium) and is read and executed by computers, thereby implementing the method according to the present invention. In addition, the recording medium includes all forms of computer readable recording medium.

As described above, according to the exemplary embodiments of the present disclosure, it is possible to provide the accurately detected position of the nondestructive system to the user by converting the sensor signal for measuring the position of the multi-axis transport system into the position information (x, y, and z coordinates) which may be matched to the detected position of the nondestructive system and then transmitting the converted position information to the nondestructive system via high speed communication (e.g., LAN or PCI).

The present disclosure described above may be variously substituted, altered, and modified by those skilled in the art to which the present disclosure pertains without departing from the scope and sprit of the present disclosure. Therefore, the present disclosure is not limited to the above-mentioned exemplary embodiments and the accompanying drawings.

What is claimed is:

1. An apparatus for transmitting a position of a multi-axis transport system, the apparatus comprising:
a sensor signal input device configured to be linked to the multi-axis transport system and receive a variety of sensor signals for measuring the position;
a position coordinate generator configured to generate three-dimensional position coordinates based on the variety of sensor signals for measuring the position which are received by the sensor signal input device; and
a position coordinate transmitter configured to transmit the three-dimensional position coordinates which are generated by the position coordinate generator to a nondestructive system.

2. The apparatus according to claim 1, wherein the sensor signal includes at least one of an encoder signal, a resolver signal, and a potentiometer signal.

3. The apparatus according to claim 1, wherein the position coordinate transmitter transmits the position coordinates to the nondestructive system in User Datagram Protocol (UDP) scheme or Transmission Control Protocol/Internet Protocol (TCP/IP) scheme by including a local area network (LAN) communication interface.

4. The apparatus according to claim 1, wherein the position coordinate transmitter transmits the position coordinates to the nondestructive system via Peripheral Component Interconnect (PCI) bus.

5. The apparatus according to claim 1, wherein the position coordinate generator generates three-dimensional position coordinates (Px, Py, Pz) using the following Equation A:
$$[ \begin{matrix}Px \\ Py \\ Pz \\ Φ \\ Θ \\ Ψ\end{matrix} ] = [ T ] [ \begin{matrix}{q}_{1} \\ {q}_{2} \\ {q}_{3} \\ {q}_{4} \\ {q}_{5} \\ {q}_{6}\end{matrix} ] \qquad [ Equation A ]$$
φ represents a roll of the multi-axis transport system, θ represents a pitch of the multi-axis transport system, ψ represents a yaw of the multi-axis transport system, T represents a kinematic transformation matrix, and qn, which is the sensor signal, represents a rotation amount of motor of each axis (n is a natural number of 1 to 6).

6. A method for transmitting a position of a multi-axis transport system, the method comprising:
receiving, by a sensor signal input device, a variety of sensor signals for measuring the position by being linked to the multi-axis transport system;
generating, by a position coordinate generator, three-dimensional position coordinates based on the variety of received sensor signals for measuring the position; and
transmitting, by a position coordinate transmitter, the generated three-dimensional position coordinates to a nondestructive system.

7. The method according to claim 6, wherein the sensor signal includes at least one of an encoder signal, a resolver signal, and a potentiometer signal.

8. The method according to claim 6, wherein in the transmitting of the position coordinates, the position coordinates are transmitted to the nondestructive system in User Datagram Protocol (UDP) scheme or Transmission Control Protocol/Internet Protocol (TCP/IP) scheme by including a local area network (LAN) communication interface.

9. The method according to claim 6, wherein in the transmitting of the position coordinates, the position coordinates are transmitted to the nondestructive system via Peripheral Component Interconnect (PCI) bus.

10. The method according to claim 6, wherein in the generating of the position coordinates, three-dimensional position coordinates (Px, Py, Pz) are generated using the following Equation B:
$$[ \begin{matrix}Px \\ Py \\ Pz \\ Φ \\ Θ \\ Ψ\end{matrix} ] = [ T ] [ \begin{matrix}{q}_{1} \\ {q}_{2} \\ {q}_{3} \\ {q}_{4} \\ {q}_{5} \\ {q}_{6}\end{matrix} ] \qquad [ Equation B ]$$
φ represents a roll of the multi-axis transport system, θ represents a pitch of the multi-axis transport system, ψ represents a yaw of the multi-axis transport system, T represents a kinematic transformation matrix, and qn, which is the sensor signal, represents a rotation amount of motor of each axis (n is a natural number of 1 to 6).
